(19) United States
(12) Patent Application Publication
(10) Pub. No.: US 2013/0055473 A1
(43) Pub. Date: Feb. 28, 2013

(54) DEVICE AND METHOD FOR DIFFERENTIATING TARGET CELL

(71) Applicants: Young-nam KWON, Gunpo-si (KR); Kee-won KIM, Suwon-si (KR); Min-seok KIM, Yongin-si (KR); Hyouk-soo HAN, Seoul (KR); Jeong-gun LEE, Seoul (KR); Hee-goo KIM, Yongin-si (KR)

(72) Inventors: Young-nam KWON, Gunpo-si (KR); Kee-won KIM, Suwon-si (KR); Min-seok KIM, Yongin-si (KR); Hyouk-soo HAN, Seoul (KR); Jeong-gun LEE, Seoul (KR); Hee-goo KIM, Yongin-si (KR)

(73) Assignee: SAMSUNG ELECTRONICS CO., LTD., Suwon-si (KR)

(21) Appl. No.: 13/591,571

(22) Filed: Aug. 22, 2012

(30) Foreign Application Priority Data
Aug. 24, 2011 (KR) 10-2011-0084817

(51) Int. Cl. G01Q 20/00

(52) U.S. Cl. 850/5

(57) ABSTRACT

A device for differentiating a target cell includes a cantilever including a fixed end and a free end, where the cantilever is elastically deformable, a tip disposed on the free end of the cantilever, where the tip contacts a surface of a cell, a measurement unit connected to the fixed end of the cantilever, where the measurement unit measures a degree of a repulsive force based on an elastic deformation of the cantilever, and a conversion unit which converts the repulsive force measured by the measurement unit into a modulus of elasticity derived from the surface of the cell.

### CROSS-REFERENCE TO RELATED APPLICATIONS

This application claims priority to Korean Patent Application No. 10-2011-0084817, filed on Aug. 24, 2011, and all the benefits accruing therefrom under 35 U.S.C. §119, the content of which in its entirety is herein incorporated by reference.

### BACKGROUND

1. Field

The present disclosure relates to a device and a method for differentiating a single cell from a plurality of cell groups by measuring a change in modulus of elasticity of a cell.

2. Description of the Related Art

In general, cell staining is widely used to differentiate cells. In the cell staining, a visible dye is bound to a cell such that a structure of the cell is confirmed through a color of the visible dye. In the cell staining, living body-derived samples mostly contain a large amount of components of various sizes and different properties and states, and thus a pre-treatment process may be further performed thereon to improve accuracy and efficiency of cell differentiation. In the cell staining for fat-containing cells, staining that uses characteristics, in which dyes are more dispersed and dissolved in lipids upon contact therewith than a solubility limit of dyes in a solvent, may be used. However, in a process of preparing samples, there is a risk of a fire and harmful dyes may be exposed to the human body. In addition, when conventional staining methods are used, a phenomenon in which black particles exist around cells due to elution of dyes may occur, which may act as a noise in determining a degree of differentiation when cells that are being differentiated are observed.

### SUMMARY

Provided are devices for differentiating a target cell.

Provided are methods of differentiating a target cell using the devices.

In an embodiment, a device for differentiating a target cell includes a cantilever including a fixed end and a free end, where the cantilever is elastically deformable, a tip disposed on the free end of the cantilever, where the tip contacts a surface of a cell, a measurement unit connected to the fixed end of the cantilever, where the measurement unit measures a degree of a repulsive force based on an elastic deformation of the cantilever, and a conversion unit which converts the repulsive force measured by the measurement unit into a modulus of elasticity derived from the surface of the cell.

In another embodiment, a method of differentiating a target cell includes measuring a repulsive force of a surface of a cell in a biological sample, and differentiating a target cell in the biological sample based on the measured repulsive force of the cell.

### BRIEF DESCRIPTION OF THE DRAWINGS

These and/or other features will become apparent and more readily appreciated from the following description of embodiments, taken in conjunction with the accompanying drawings in which:

FIG. 1 is a block diagram illustrating an embodiment of a device for differentiating a target cell according to the invention;

FIG. 2 is a schematic diagram showing an embodiment of a method of differentiating a target cell using a device for differentiating a target cell according to the invention;

FIG. 3 is a graph showing modulus of elasticity of a cell, which is evaluated using an embodiment of a device for differentiating a target cell according to the invention;

FIG. 4A is a microscopic image of fat cells prior to differentiation;

FIG. 4B is a graph showing vertical deflection (nanoNewton: nN) versus height (micrometer: μm) measured for differentiating undifferentiated fat cells of FIG. 4A using an embodiment of a device for differentiating a target cell according to the invention;

FIG. 4C is a microscopic image of fat cells that are differentiated for 10 days;

FIG. 4D is a graph showing vertical deflection (nN) versus height (μm) measured for differentiating the differentiated fat cells of FIG. 4C using an embodiment of a device for differentiating a target cell according to the invention;

FIGS. 5A and 5B illustrate distribution of differentiated fat cells in a sample according to a degree of differentiation of fat cells using an embodiment of a device for differentiating a target cell according to the invention; and

FIGS. 6A to 6D illustrate results of differentiating fat cells prior to differentiation and fat cells that are differentiated for 10 days using a flow cytometric analysis.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

According to an embodiment of the invention, a device for differentiating a target cell includes: a cantilever including a fixed end and a free end and is elastically deformable; a tip which is disposed on the free end of the cantilever and contacts a surface of a cell; a measurement unit which is connected to the fixed end of the cantilever and measures a degree of a repulsive force based on an elastic deformation of the cantilever; and a conversion unit which converts the repulsive force measured by the measurement unit to a modulus of elasticity derived from the surface of the cell.

In an embodiment, the device may further include a movement unit configured to move the cantilever in an up, down, left or right direction. In such an embodiment, the movement unit may be connected to the fixed end of the cantilever and automatically or manually transfers the cantilever to allow the tip to contact and to be separated from the target cell.

In an embodiment, the device may further include a sample providing unit which is disposed below the tip and provides a biological sample.

In an embodiment, the device may further include an output unit which outputs the value of modulus of elasticity derived from the surface of the cell which is converted by the conversion unit to a user.

In an embodiment, the cantilever includes the free end and the fixed end, and the tip which contacts a biological sample. In such an embodiment, a target cell may be in contact with the free end thereof.

In an embodiment, the cantilever may have a spring constant (k) in the range of about 0.001 newton per meter (N/m) to about 1 newton per meter (N/m). In an embodiment, for example, the cantilever may have a spring constant (k) in a range of about 0.001 N/m to about 0.5 N/m. In another embodiment, for example, the cantilever may have a spring constant (k) in a range of about 0.001 N/m to about 0.3 N/m. The modulus of elasticity of the surface of the cell may be confirmed by measuring a force distances of a plurality of cells in the biological sample using the cantilever that has the spring constant within the range described above. In an embodiment, the spring constant (k) of the cantilever may be about 1 N/m or less such that a force on the cells may be substantially small. In such an embodiment, where the spring constant (k) of the cantilever is selected as substantially small value, most of the force on the tip when the tip passes a surface of the biological sample is represented as deflection of the cantilever, and thus the deformation of cells may be relatively reduced. In an embodiment, a micro cantilever used in atomic force microscopy (“AFM”) to shape a microstructure in atomic units and having a spring constant (k) in a range of about 0.01 N/m to about 0.05 N/m may be used. In an embodiment, the cantilever may include an elastic material, for example, silicon or carbon nanotubes, but is not limited thereto. In an embodiment, the cantilever may include a coating material, coated thereon, for example, aluminum (Al) or platinum/iridium (Pt/Ir), but not being limited thereto.

In an embodiment, the tip may be variously fabricated based on the size of a target cell. In an embodiment, for example, the tip may have a diameter in the range of about 1 nanometer (nm) to about 100 nanometers (nm). In another embodiment, for example, the tip may have a diameter in the range of about 1 nm to about 50 nm. In another embodiment, for example, the tip may have a diameter in the range of about 1 nm to about 10 nm. The tip of the cantilever may be a tip that has diameter of a contact area of about 10 nm upon contact with the surface of the cell in the biological sample. In such an embodiment, the diameter of the contact area is related to image resolution when the surface of the cell is captured as an image. In such an embodiment, the smaller the diameter of the contact area is, the higher the image resolution is. In an embodiment, the side of the tip may be in the form of a triangle or a cone. The term “diameter” used herein refers to a diameter of the endmost portion of the tip which contacts the biological sample.

In an embodiment, the measurement unit may be connected to the fixed end of the cantilever and may measure the size of repulsive force based on a degree of elastic deformation of the cantilever. The cantilever is elastically deformable and thus the repulsive force of the cantilever may be determined based on the deflection of the cantilever when the tip contacts and is then separated from a target cell.

In an embodiment, the conversion unit may convert the repulsive force measured by the measurement unit to elasticity values derived from a surface of the cell. The elasticity values denote modulus of elasticity. A unique modulus of elasticity of a surface of a cell, which is measured as a distance between the tip and the surface of the cell becomes substantially close to each other, may be evaluated by comparing deflection degrees of the cantilever, i.e., repulsive forces with each other.

In such an embodiment, the elasticity information may be output by the output unit to a user.

According to another embodiment of the invention, a method of differentiating a target cell includes: measuring a repulsive force of a surface of a cell in a biological sample; and differentiating a target cell based on the measured repulsive force of the cell.

The differentiating process of the target cell will now be described in greater detail.

The method may include measuring a repulsive force of the surface of the cell in the biological sample.

In an embodiment, the differentiating process may be performed by comparing measured repulsive forces of a plurality of cells with each other. In such an embodiment, the differentiating of the target cell may be performed by measuring the repulsive force of a plurality of cells in the biological sample and comparing the repulsive forces of the plurality of cells with each other.

The differentiating process may be performed by comparing a measured repulsive force of the cell in the biological sample with a measured repulsive force of a reference cell. In an embodiment, for example, a target cell in a biological sample may be differentiated based on repulsive forces of reference cells including various types of cells, which are pre-measured and stored in database. In such an embodiment, a repulsive force of a cell in the biological sample is measured using the method described above, and the measured repulsive force of the cell is compared with the pre-measured repulsive forces of the reference cells stored in database.

In an embodiment, the measuring of the repulsive force may include contacting the cell with the tip of the device; and separating the contacted tip from the cell and measuring a generated repulsive force of the cantilever.

In an embodiment, the tip of the device may automatically contact the target cell or be manually contacted to the target cell via the movement unit of the device.

In an embodiment, the biological sample may be any biological sample that may contain the target cell, and, for example, may be at least one of a biopsy specimen, a tissue sample, a cell suspension obtained by suspending isolated cells in a liquid medium and a cell culture. In an embodiment, the biological sample may be a body fluid of an animal, and the body fluid may be at least one of blood, bone marrow fluid, lymphatic fluid, saliva, lachrymal fluid, urine, mucous membrane fluid and amniotic fluid, but is not limited thereto. The biological sample may be a group of adipocytes that are in differentiation.

The plurality of cells may be cells having different sizes, and the target cell may be one of an osteoblast, a chondrocyte, an adipocyte, a circulating tumor cell, a cancer stem cell, an immunocyte, a fetal stem cell, a fetal cell, a cancer cell, a tumor cell, a myoblast, a fibroblast, a satellite cell and an induced pluripotent stem cell, for example, but is not limited thereto. In an embodiment, the target cell may be a single cell.

In an embodiment, the method may include differentiating a target cell by comparing measured repulsive forces of a plurality of cells with each other.

In an embodiment, the tip contacted to the biological sample by the movement unit may be separated therefrom by the movement unit. In such an embodiment, the cantilever that has a certain spring constant generates a repulsive force. The generated repulsive force may be measured by the measurement unit of the device.

A detailed description of elastic values is already provided in the description of the device. The modulus of elasticity may be derived from a cell existing in the biological sample. Thus, the modulus of elasticity varies according to types of cells existing in a sample and physical properties thereof (e.g., the size of cell), and thus a target cell existing in a biological sample may be differentiated by the modulus of elasticity.

Hereinafter, embodiments of the invention will be described in further detail with reference to the accompanying drawings.

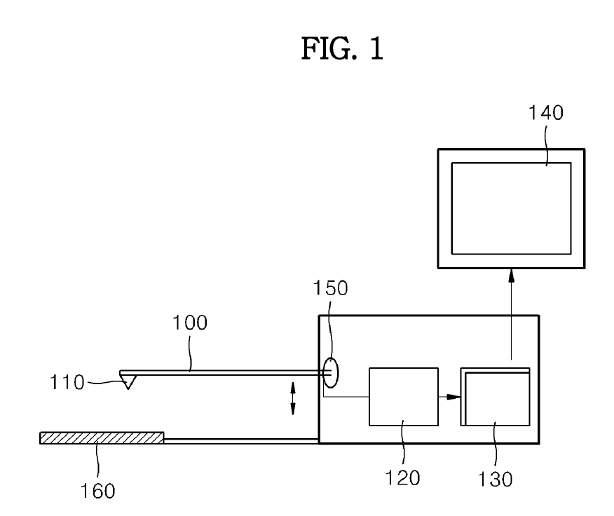

FIG. 1 is a block diagram illustrating an embodiment of a device for differentiating a target cell according to the invention. The device includes a cantilever 100 including a free end and a fixed end; a tip 110 connected to the free end of the cantilever 100; a measurement unit 120 that is connected to the fixed end of the cantilever 100 and measures a degree of a repulsive force of the cantilever 100; and a conversion unit 130 that converts the repulsive force measured by the measurement unit 120 into elasticity information on a surface of the cell. In such an embodiment, the device may further include an output unit 140 that outputs the information generated from a conversion unit 130 to a user, and a movement unit 150 configured to move the cantilever 100 in an up, down, left, or right directions and which automatically or manually operable. In such an embodiment, the device may further include a sample providing unit 160 disposed below the tip 110 and provides a biological sample, which is a subject.

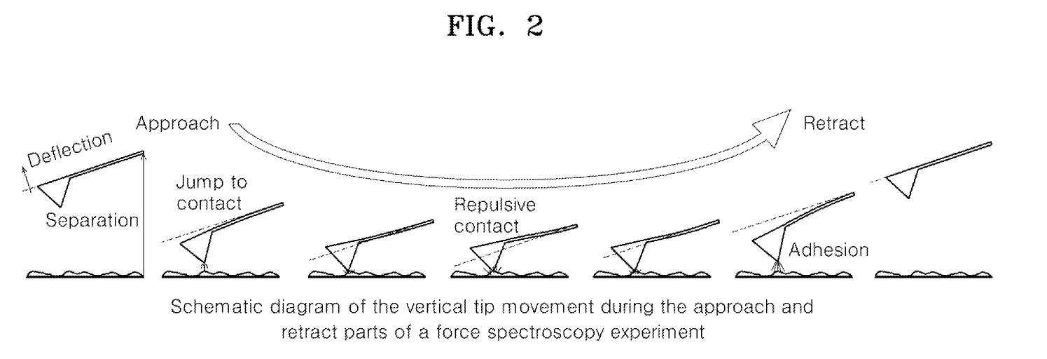

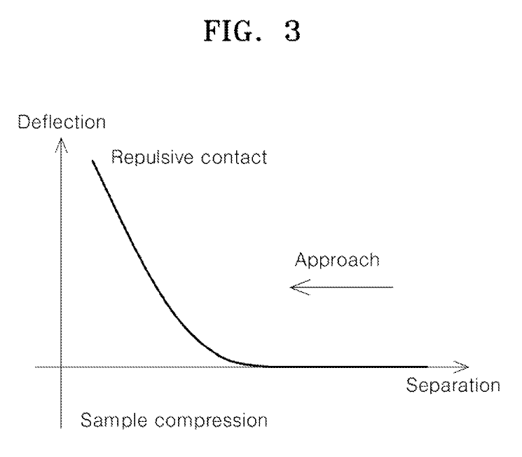

FIG. 2 is a schematic diagram showing an embodiment of a method of differentiating a target cell using a device for differentiating a target cell according to the invention. The cantilever 100 fixed to the device for differentiating a target cell is moved by the movement unit 150 to allow the tip 110 connected to the free end of the cantilever 100 to contact a cell in the biological sample. Since the cantilever 100 has a certain spring constant, a repulsive force is generated on the cantilever 100 with the tip connected thereto when the tip 110 contacts the cell and is then separated from the cell, and the measurement unit 120 connected to the fixed end of the cantilever 100 measures the repulsive force. In such an embodiment, as illustrated in FIG. 3, the deflection of the cantilever 100 with respect to a distance between the cell and the tip 110 is measured, and the measured repulsive force is converted by the conversion unit 130 into elasticity information on a surface of the cell. In such an embodiment, by the measuring the repulsive forces of a plurality of cells in the biological sample, physical properties of each of the plurality of cells are evaluated, whereby the target cell is differentiated.

### Example 1

### Differentiation Test of Human Adipocytes Using an Embodiment of the Device for Differentiating Target Cell

Adipogenic differentiated cells contain a large amount of lipid droplets and the size thereof is about 200 times or greater than the size of undifferentiated cells, and thus adipogenic differentiated cells have different physical properties from the undifferentiated cells. Thus, an experiment for differentiating two kinds of the cells using an embodiment of the device for differentiating a target cell was performed.

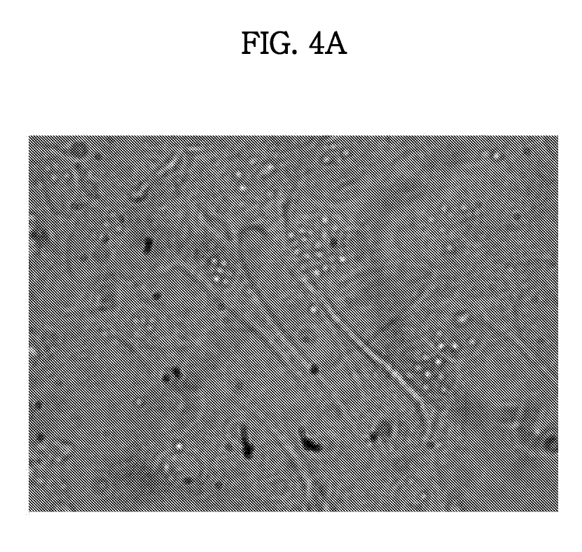

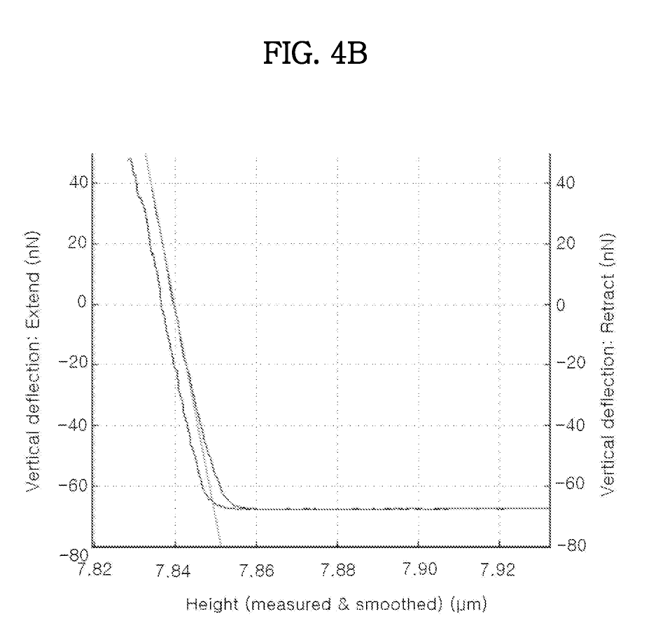

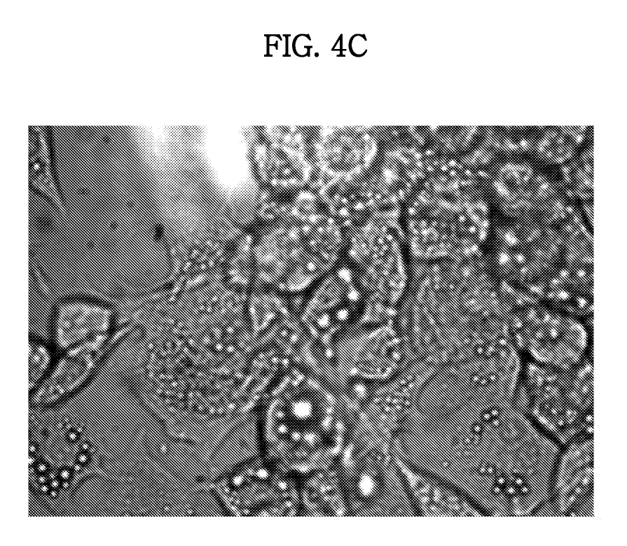

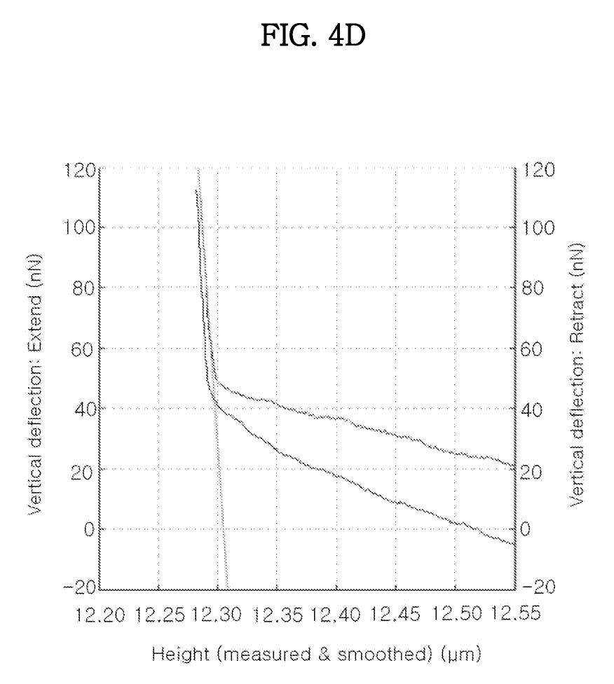

FIG. 4A is a microscopic image of fat cells prior to differentiation, FIG. 4B is a graph showing vertical deflection (nanoNewton: nN) versus height (micrometer: μm) measured for differentiating undifferentiated fat cells of FIG. 4A using an embodiment of a device for differentiating a target cell according to the invention, FIG. 4C is a microscopic image of fat cells that are differentiated for 10 days, and FIG. 4D is a graph showing vertical deflection (nN) versus height (μm) measured for differentiating the differentiated fat cells of FIG. 4C using an embodiment of a device for differentiating a target cell according to the invention

FIGS. 4A and 4C are charged-coupled device (“CCD”) images of undifferentiated cells (FIG. 4A) and cells that are differentiated into adipocytes for 10 days (FIG. 4C), taken by a microscopy at a magnification of ×1,000. FIGS. 4B and 4D are graphs showing results of differentiating the undifferentiated cells and the adipogenic differentiated cells using an embodiment of the device for differentiating a target cell.

In the graphs of FIGS. 4B and 4D, the x-axis denotes a height between a surface of a slide to which a biological sample is provided and a cantilever, and the y-axis denotes a state of the cantilever, e.g., the deflection of the cantilever. As illustrated in the images and graphs of FIGS. 4A to 4D, the undifferentiated cells and the cells that are differentiated into adipocytes for 10 days show a difference in repulsive forces generated when the tip connected to the cantilever of the device contacts and is then separated from the cells, and thus slopes of the two graphs are different. By measuring such slopes, physical properties (e.g., size of cells) of the cells are evaluated. The slopes physically correspond to “modulus of elasticity” or “Young's modulus.” The measurement results are stored in a database and statistically analyzed to measure slope information with respect to reference cells, and such information is stored in the device such that the cell measured by the device is differentiated.

### Example 2

### Differentiation of Human Adipocytes Using a Device for Differentiating Target Cell and Comparative Experiment for Cell Differentiation Using a Flow Cytometric Device

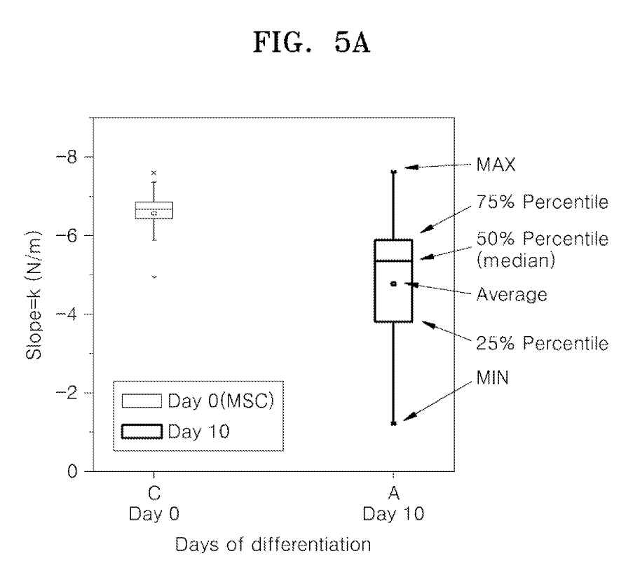

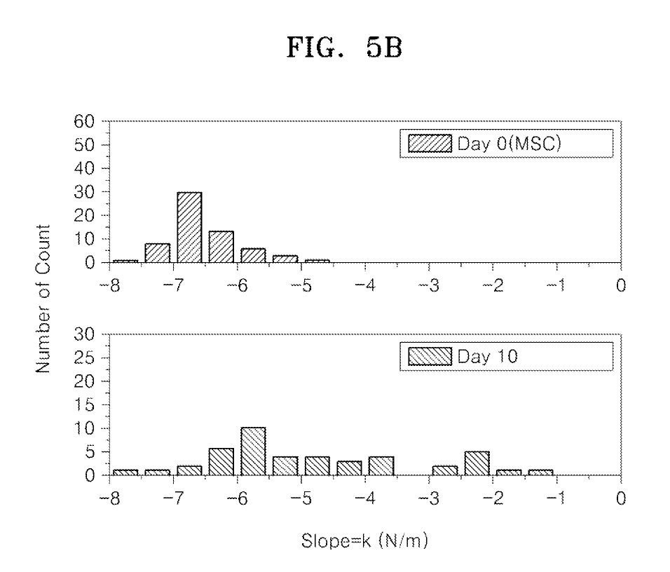

FIGS. 5A and 5B illustrate distribution of differentiated adipocytes in a sample according to a degree of differentiation of adipocytes using an embodiment of a device for differentiating a target cell. A sample containing the undifferentiated adipocytes, e.g., mesenchymal stem cell (“MSC”), and a sample containing the adipocytes differentiated for 10 days were prepared, and the contacting and separating of each sample to and from the device were repeatedly performed 100 times such that adipocytes are differentiated in each sample. In the experiment, as illustrated in FIGS. 5A and 5B, the modulus of elasticity of the adipocytes differentiated for 10 days was variously detected to be −1 to 8, while the modulus of elasticity of the undifferentiated adipocytes was −5 to 8.

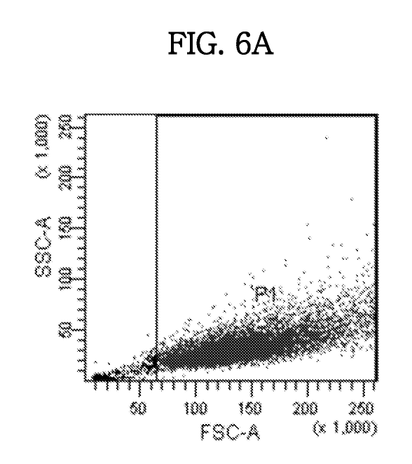

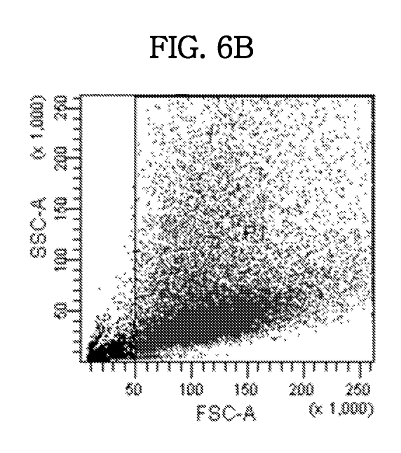

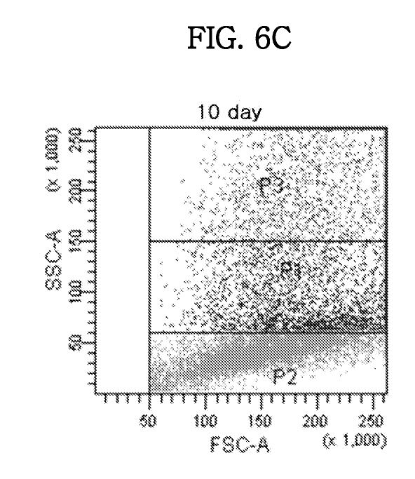

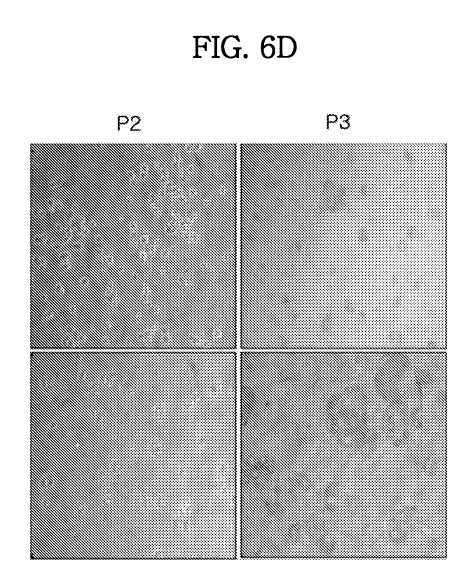

A cell size distribution of each sample was measured using the flow cytometric device, e.g., a fluorescence-activated cell sorter (“FACS®”) device. As illustrated in FIGS. 6A to 6D, the sizes of the adipocytes differentiated for 10 days are variously detected as compared to the undifferentiated adipocytes. As illustrated in microscopic images of FIG. 6D, a plurality of cells containing lipid droplets exist in the adipocytes differentiated for 10 days. In FIGS. 6A to 6C, the x-axis and the y-axis denote the forward scatter pulse area (“FSC-A”) and the side scatter pulse area (“SSC-A”), respectively.

As shown in FIGS. 5A to 6E, the differentiation results of adipocytes using an embodiment of the device for differentiating a target cell are substantially the same as the differentiation results of adipocytes using the FACS® device.

As described above, according to the one or more embodiments of the invention, a target cell in a biological sample may be efficiently differentiated using the device and method for differentiating a target cell.

It should be understood that the embodiments described therein should be considered in a descriptive sense only and not for purposes of limitation. Descriptions of features within each embodiment should typically be considered as available for other similar features in other embodiments.

What is claimed is:

1. A device for differentiating a target cell, the device comprising:
a cantilever including a fixed end and a free end, wherein the cantilever is elastically deformable;
a tip disposed on the free end of the cantilever, wherein the tip contacts a surface of a cell;
a measurement unit connected to the fixed end of the cantilever, wherein the measurement unit measures a degree of a repulsive force based on an elastic deformation of the cantilever; and
a conversion unit which converts the repulsive force measured by the measurement unit into a modulus of elasticity derived from the surface of the cell.

2. The device of claim 1, further comprising:
a movement unit configured to move the cantilever in an up, down, left or right direction.

3. The device of claim 1, wherein the cantilever has a spring constant in a range of about 0.001 newton per meter to about 1 newton per meter.

4. The device of claim 1, further comprising:
an output unit which outputs to a user the modulus of elasticity derived from the surface of the cell which was obtained by the conversion unit.

5. The device of claim 1, wherein the tip has a diameter in a range of about 1 nanometer to about 100 nanometers.

6. The device of claim 1, further comprising:
a sample providing unit disposed below the tip,
wherein the sample providing unit provides a biological sample.

7. A method of differentiating a target cell, the method comprising:
measuring a repulsive force of a surface of a cell in a biological sample; and
differentiating a target cell in the biological sample based on the measured repulsive force of the cell.

8. The method of claim 7, wherein the differentiating the target cell comprises:
comparing the measured repulsive force of the surface of the cell with a repulsive force of another cell in the biological sample.

9. The method of claim 7, wherein the differentiating the target cell comprises:
comparing the measured repulsive force of the surface of the cell with a repulsive force of a reference cell, wherein the repulsive force of the reference cell is pre-measured.

10. The method of claim 7, wherein the measuring the repulsive force of the surface of the cell in the biological sample comprises:
contacting the cell with a tip of a device for differentiating the target cell; and
separating the contacted tip from the cell to measure a generated repulsive force of a cantilever,
wherein the device for differentiating the target cell comprises:
the cantilever including a fixed end and a free end, wherein the cantilever is elastically deformable;
the tip disposed on the free end of the cantilever, wherein the tip contacts the cell;
a measurement unit connected to the fixed end of the cantilever, wherein the measurement unit measures a degree of the repulsive force based on an elastic deformation of the cantilever; and
a conversion unit which converts the repulsive force measured by the measurement unit into a modulus of elasticity derived from the surface of the cell.

11. The method of claim 7, wherein the target cell is at least one selected from the group consisting of an osteoblast, a chondrocyte, an adipocyte, a circulating tumor cell, a cancer stem cell, an immunocyte, a fetal stem cell, a fetal cell, a cancer cell, a tumor cell, a myoblast, a fibroblast, a satellite cell and an induced pluripotent stem cell.

12. The method of claim 7, wherein the target cell is a single cell.

13. The method of claim 7, wherein the biological sample comprises a group of adipocytes, which are in differentiation.

14. The method of claim 10, wherein the device for differentiating the target cell further comprises:
a movement unit configured to move the cantilever in an up, down, left or right direction.

15. The method of claim 10, wherein the cantilever of the device for differentiating the target cell has a spring constant in a range of about 0.001 newton per meter to about 1 newton per meter.

16. The method of claim 10, wherein the device for differentiating the target cell further comprises:
an output unit which outputs to a user the modulus of elasticity derived from the surface of the cell which was obtained by the conversion unit.

17. The method of claim 10, wherein the tip of the cantilever of the device for differentiating the target cell has a diameter in a range of about 1 nanometer to about 100 nanometers.

18. The method of claim 10, wherein the device for differentiating the target cell further comprises:
a sample providing unit disposed below the tip,
wherein the sample providing unit provides a biological sample.
